(19) United States
(12) Patent Application Publication
(10) Pub. No.: US 2026/0210741 A1
(43) Pub. Date: Jul. 23, 2026

(54) MONITORING ONE OR MORE OBJECTS USING AN OPTICAL FIBER FOR CHANGES IN CONDITION THEREOF

(71) Applicant: Network Integrity Systems, Inc., Hickory, NC (US)

(72) Inventors: Cary R. Murphy, Hickory, NC (US); Mark K. Bridges, Hickory, NC (US); Dave E. Cunningham, Conover, NC (US); Trampus L. Landrum, Hickory, NC (US)

(21) Appl. No.: 19/033,794

(22) Filed: Jan. 22, 2025

(51) Int. Cl. G01D 5/353

(52) U.S. Cl. CPC G01D 5/35367

(57) ABSTRACT

A series of spaced objects are monitored for changes in condition by providing a sensor at each object, connecting the sensors to an optical sensor fiber and using an OTDR processor for receiving therefrom signals reflected back from the sensors where the OTDR processor is arranged to generate an output which indicates and identifies receipt of a reflected signal received from the sensors. Each sensor is connected to the optical sensor fiber by a respective tap coupler which extracts a part only of the transmitted optical signal for transmission to the sensor while a further part of the optical signal continues on the optical sensor fiber. Changes in reflectance at each sensor are obtained by looping back to the optical sensor fiber said at least part of the received thereby and by attenuating an amount of the signal which is looped back.

This invention relates to a method of monitoring one or more objects and typically a plurality of the objects for changes in condition thereof using an optical fiber which connects between the objects.

The present system can be used for example to refine the application of the fiber optic alarms to junction boxes, manholes and handholes, user lock boxes, and access doors among other point of access or entry. However the method can also be used with other objects such as valves, switches and float switches. In many cases the method is used with objects which have two conditions such as open and closed or on and off to determine which of the two conditions the object is in. However the method can also be used to detect gradated changes between the two states.

### BACKGROUND OF THE INVENTION

As is shown in the applicants' U.S. Pat. No. 9,046,669 HARDWARE AND METHODS FOR SECURE ALARMED ARMORED PROTECTIVE DISTRIBUTION SYSTEMS AND MANAGEMENT, a door on an enclosure can be alarmed for the action of opening or closing by monitoring a fiber attached to the door with a motion detection system such as shown in U.S. Pat. Nos. 7,142,737, 7,092,586, and 7,706,641. However the steady state of openness or closed will not be detected by those methods described.

One method that has been commercialized is using an Optical Time Domain Reflectometer (OTDR) detecting the macrobend loss or attenuation of an optical fiber incurred by opening the door or lid, with several sensors distributed in succession along the fiber for a multitude of doors or lids. This solution has the advantage that the location of the sensor, and therefore the identification of the sensor at a particular object, is reported as a function of distance on the OTDR. This approach is problematic in that with every open lid, the system dynamic range drops until it is not possible to read sensors farther down the optical path.

A second commercialized system utilizes mechanical sensors with Fiber Bragg Grating (FBG) sensors enclosed in mechanical systems which hold the FBG in one of two states for open or closed. As FBGs reflect back their specific wavelength and pass all others, this solution has an advantage over the OTDR method above: Neglecting splice loss and fiber insertion loss, the FBG solution does not depreciate system range as the conventional OTDR does with open sensors introducing detectable loss.

The FBG system has however two disadvantages—
—a— Each location is set to a specific wavelength, therefore in the event of a failure the unit must be replaced with an exact duplicate, or if none is available the system must be recalibrated with the new wavelength. This requires service personnel to have available units of various and specific wavelengths.
—b— The broad wavelength transmission and spectrum analyzer type receiver optics are costly to produce. The system cost of a low unit count installation can be problematic.

### SUMMARY OF THE INVENTION

According to a first aspect of the invention there is provided a method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
placing the sensors of said at least one object in contact with said optical sensor fiber;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensor of said at least one object;
wherein the sensor of said at least one object is connected to the optical sensor fiber by a respective tap coupler which extracts a part only of the transmitted optical signal for transmission to the sensor while a further part of the optical signal continues on the optical sensor fiber;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensor of said at least one object.

The term “reflected back” or “reflectance” used herein has the meaning that the optical signal concerned is returned back in the opposite direction to its initial travel. This can include a surface which is mirrored but is not limited thereto.

In most cases the method is used for monitoring a plurality of objects for changes in condition of each of the objects where the method includes:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein each sensor is connected to the optical sensor fiber by a respective one of a plurality of tap couplers each of which extracts a part only of the transmitted optical signal for transmission to the sensor while a further part of the optical signal continues on the optical sensor fiber to others of the sensors;
wherein the movable member of each respective sensor is arranged to change a level of reflectance of the respective sensor so as to change a proportion of the optical signal which is reflected back;
and wherein the output of the OTDR processor is arranged to indicate the change in the level of reflectance of each of the sensors.

In many cases the object is movable between discrete first and second conditions and the movable member of the respective sensor is arranged to change a level of reflectance of the respective sensor so as to change a proportion of the optical signal which is reflected back from a high reflectance at the first condition to a low reflectance at the second condition. However the movable member can be used to provide a gradated change in signal rather than just two extreme or discrete positions.

In the preferred method, the first and second conditions relate to specific first and second positions of the object to be monitored. These can be open or closed, empty or full, on or off etc depending on the type of object to be monitored.

Many different arrangements can be provided to reflect back or return the signals from the optical fiber. In one arrangement the sensor is arranged to receive at least part of the transmitted optical signal and to reflect back at least a part of the transmitted optical signal received thereby by looping back to the optical sensor fiber the part received thereby. In this arrangement, the level of reflectance can be changed by attenuating an amount of the signal which is looped back. This attenuation can be done in different ways but one example uses a portion of fiber where the movable member of the object provides a macrobending action on the portion to attenuate the signal in the fiber in known ways. Typically the signal can be looped back by a coupler. Thus the movable member can be arranged to change a level of reflectance of the sensor by passing the optical signal through a loop of fiber and attenuating the signal by bending the loop of fiber by the movement of the movable member responsive to the movement of the object. This can be a 50/50 coupler to return the signal without reduction but this can be changed to different values.

This method can preferably be used for monitoring a series of such objects such as doors where each of the objects is movable between first and second conditions such as open and closed and where the movable member of each respective sensor is arranged to change a level of reflectance of the respective sensor so as to change a proportion of the optical signal which is reflected back from a high reflectance at the first condition to a low reflectance at the second condition. In this way, the output indicates and identifies that all of the sensors are in the first condition by receipt from each of the sensors of a high reflected signal at the high reflectance. In this way the output indicates and identifies which of the of sensors are in the second condition by receipt from each of the sensors of a low reflected signal at the low reflectance. This can be displayed visually where the majority of traces shown provide high peak and from the first condition and those objects moved to the second condition an be easily and readily displayed by an absence or collapse in the trace so as to easily show which of the sensors are in the second condition.

In another arrangement, the movable member is arranged to reflect back the optical signal by transmitting the optical signal across a space between collimating lens arrangements and to change a level of reflectance of the sensor by attenuating the optical signals in the space. Thus an obstruction can be provided in the space which is moved between obstructing and non-obstructing positions.

In another arrangement, the movable member is arranged to change a level of reflectance of the optical signal by the sensor by providing a termination at an end of a fiber which termination provides a first level of reflectance at the termination and by bringing into engagement with the termination a component which allows the optical signal to enter the component from the termination and to have a second level of reflectance which is different from the first level of reflectance.

For example in one arrangement, the component comprises a ferrule with an end of the ferrule which provides the second level of reflectance.

This can be carried out where the fiber is terminated by a perpendicular face which provides a Physical contacting back reflection. In this case the ferrule provides a connection to the perpendicular face which allows the signal to enter the ferrule, which itself has a non-reflecting end so that the signal when entering the ferrule is not reflected back thus changing the state of reflectance from total reflectance to non-reflectance.

Alternatively this can be carried out where the fiber is terminated by an angled face which provides an Angled Physical contacting back reflection which prevents the signal from being returned in the fiber and wherein the ferrule provides a connection to the angled face which allows the signal to enter the ferrule which has a reflecting end.

Additionally this non-reflective end can be accomplished with a ferrule or fiber end treated with index matching gel or other device intended to suppress reflection.

According to a second aspect of the invention there is provided a method for monitoring a plurality of objects for changes in condition of each of the objects comprising:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein the movable member of each respective sensor is arranged to change a level of reflectance of the respective sensor so as to change a proportion of the optical signal which is reflected back;
wherein each of the objects is movable between first and second conditions;
wherein the movable member of each respective sensor is arranged to change a level of reflectance of the respective sensor so as to change a proportion of the optical signal which is reflected from a high reflectance at the first condition to a low reflectance at the second condition;
and wherein the output indicates and identifies that all of the sensors are in the first condition by receipt from each of the sensors of a high reflected signal at the high reflectance and indicates and identifies which of the of sensors are in the second condition by receipt from each of the sensors of a low reflected signal at the low reflectance such that the output visually shows which of the sensors are in the second condition.

According to a third aspect of the invention there is provided a method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensors of said at least one object;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensors of said at least one object;
wherein the sensors of said at least one object is arranged to receive at least part of the transmitted optical signal and to reflect back at least a part of the transmitted optical signal received thereby by looping back to the optical sensor fiber said at least part of the signal received thereby;
and wherein the signal reflected back from each of the sensor of said at least one object is changed by attenuating an amount of the signal which is looped back.

According to a fifth aspect of the invention there is provided a method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensors of said at least one object;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensors of said at least one object;
wherein the sensors of said at least one object is arranged to receive at least part of the transmitted optical signal and to reflect back at least a part of the transmitted optical signal received thereby by transmitting the optical signal across a space between collimating lens arrangements and to change a level of reflectance of the sensor by attenuating the optical signals in the space.

According to a sixth aspect of the invention there is provided a method for to change a level of reflectance of an optical signal by an optical fiber comprising:
providing a termination at an end of the fiber which termination provides a first level of reflectance at the termination and by bringing into engagement with the termination a component which allows the optical signal to enter the component from the termination and to have a second level of reflectance which is different from the first level of reflectance.

According to a seventh aspect of the invention there is provided a method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensor of said at least one object;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensors of said at least one object;
wherein the movable member is arranged to change a level of reflectance of the optical signal by the method according to claim 1.

Thus, as set out above and described in more detail hereinafter, there is described herein a passive fiber optic sensor device for detecting the state of a door or other barrier as open or closed without powered components at the point of detection. This is a binary state, and detection is done using fiber optics. The design will allow multiple sensing systems to be deployed along a single Optical Time Domain Reflectometer (OTDR) channel, reporting state and verifying location.

Thus a variation on the OTDR method is presented which solves three issues:
The system range is not affected by the loss of any or all sensors;
The sensors are not wavelength dependent, therefore only one universal replacement needs to be available to service personnel. The generic sensor can be placed anywhere along the installation fiber without additional wavelength considerations;
As no swept or broadband optical source are required, a sweeping optical spectrum analyzer detection system is not required, the cost is relatively low.

In the arrangement described herein, a single strand of optical fiber exits a standard Optical Time Domain Reflectometer, with tap couplers installed along the fiber routing a small percentage of the signal to a sensor. The tapped signal presents distributed reflections to the OTDR signal. This can be seen below as a spike representing each sensor.

The arrangement can use as many sensors as allowed by the dynamic range of the OTDR. The tap coupler extracts for each sensor a small portion of the signal which can be very low such as 1% to 3% or can be larger if suitable for the system.

The main fiber carrying the main signal typically around 99%, passes the OTDR pulses and responses back with minimum loss. This allows daisy chaining of many devices in one OTDR circuit.

The 1% tap injects a small portion of the pulse into the sensor device which can use a 50:50 coupling device to take the 1% signal and inject it back into the return path of the fiber to the OTDR. This creates a high power, repeatable, simulated reflection. An OTDR is a device that injects pulses of laser light into an optical fiber, and interrogates the reflections, of which there are two primary types-Rayleigh backscattering and Fresnel reflections. Rayleigh is not suitable for this design as the insertion loss of the fiber as affected by the Rayleigh backscattering defines the maximum distance between, and the insertion loss of, the detection modules. Fresnel is caused by the reflection of caused at the interface of dissimilar fiber refractive indices. This is mentioned as the signal caused by the above modules is similar in appearance to Fresnel, although not necessarily caused by the same mechanism.

In the above design, in a steady state where the door or opening is closed, the loop of fiber will be undisturbed. When the door is opened, the loop is compressed, causing loss due to macrobending. The devices can be separated by a few hundred meters of fiber, and simulating all doors closed. When the third sensor is macrobent, simulating an open door, the trace disappears. This allows detection of the opening, and the location is calculated by the OTDR my measuring the round-trip time of flight of the laser pulse.

An advantage of this system is an immunity to defeating by cutting or unplugging the device as it will present a lost pulse, indicating an alarm to be addressed. In one example a manhole lid sensor with a 3% tap coupler can be used, however this is applicable to a variety of closures such as lids and doors, with a variety of tap ratios.

Some Versions of the Sensor Mechanism:
Coupled Loopback; where the preferred embodiment is to feed the low percentage tap into a 1×2 coupler, the output legs are optically connected such as by splicing. In this configuration, each leg of the output of the coupler feeds into the opposite leg, thereby injecting an optical signal into the other leg. This has the effect of returning a significant amount of the light back though the tap coupler and returns as a spike.

The actuation occurs when the loop or the fiber feeding the loop are macrobent as the actuator.

Lensed loopback; where another mechanism for the sensor reflection control is passing the low percentage tap through a 1×2 coupler. The two legs of the coupler each feed a collimating lens such as a graded index (GrIn) or self focusing (SelFoc) lens. A blocking mechanism blocks the light being returned as a spike.

Fresnel reflection; where the spike can be caused by terminating the 1% or other low percentage tap with a moving fiber mechanism. In this example, the fiber is terminated in a standard ferrule from an optical connector and inserted in a sleeve. A similar ferrule which is terminated with a non-reflective termination is slid in and out of the sleeve by the action of the sensor. When inserted, the reflection disappears or lessens on the OTDR display. One example is a manhole lid sensor with a 3% tap coupler, however this is applicable to a variety of closures such as lids and doors, with a variety of tap ratios.

An important feature of the invention is that when the door is open, the fiber loop (describe the fiber loop) compresses and macrobends the fiber loop, thereby attenuating the signal. When the door is in the closed condition, the loop is relaxed and free of bend loss.

The movable member used can include magnetic actuation for use where the object is hermetic sealed to avoid the movable member from interfering with the seal.

The system is particularly suitable in the following examples:
Manhole lid sensor;
Enclosure door;
Lockbox door;
Protected Distribution System (PDS)
Non-PDS applications;
Outside plant PDS;
Outside plant non-pds security;
Doors;
Secure rooms
Gates;
Windows;
Valves;
Float Switch;

Any other mechanism where the open/close state needs to be monitored.

### BRIEF DESCRIPTION OF THE DRAWINGS

FIG. 1 is a schematic illustration of a system and method according to the invention for monitoring by use of an optical fiber the condition of one or more and typically a plurality of objects.

FIG. 2 is a schematic illustration of one example of a movable member operated by an object for use in the system of FIG. 1.

FIG. 3 is a schematic illustration of the example of a movable member operated by an object for use in the system of FIG. 1 as shown in FIG. 2 which is in the condition where the loop of fiber is distorted or Macrobent.

FIG. 4 is a schematic illustration of a further example of a movable member operated by an object for use in the system of FIG. 1.

FIG. 5 is a schematic illustration of a further example of a system and method according to the invention for monitoring by use of an optical fiber the condition of one or more and typically a plurality of objects where the signals from the OTDR are looped back and attenuated by a different method.

FIGS. 6 to 8 are schematic illustrations of a further system and method according to the invention for monitoring by use of an optical fiber the condition of a plurality of objects where the reflectance of the fiber is changed by moving a termination having a second reflectance into engagement with an end of a fiber having a first reflectance.

FIGS. 9 and 10 are graphical illustrations of the traces from the individual sensors showing high and low reflectance and the immediately apparent location of any low reflectance trace.

### DETAILED DESCRIPTION

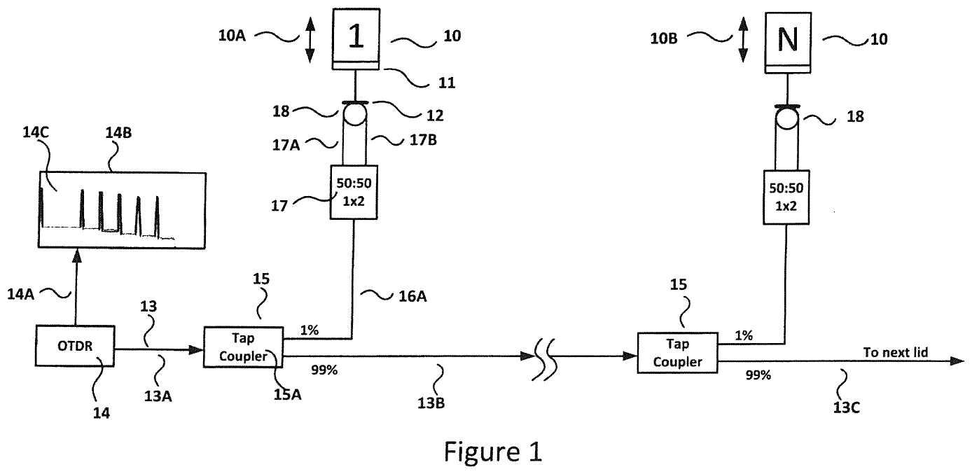

As shown particularly in FIG. 1 there is provided a method for monitoring a series of objects 10 including as shown object 10-1 up to 10-n for changes in condition of the object. As discussed above the object may be provided by any one of a series of examples where each object has two conditions 1 and 2 such as for example open and closed.

Each object has a sensor 11 for detecting the condition of the object so that the sensor is responsive to the object being in condition 1 or in condition 2. The sensor includes a movable member 12 responsive to the change in condition of the object to be monitored.

A main optical sensor fiber 13 extending to each object to be monitored in turn and includes fiber sections 13A, 13B, 13C etc. Thus the objects are arranged at spaced locations along the fiber so that each sensor is placed in contact with the optical sensor fiber 13 and can receive and return signal to the fiber. Although shown in a row at equal spacing, there is no requirement for the fiber to follow a specific path and to locate the objects at specific locations along the fiber since in the alternative the fiber may be deformed and guided to the objects in whatever locations they are placed.

The fiber 13 communicates with an OTDR processor 14 for transmitting optical signals along the fiber and for receiving therefrom signals reflected back on the fiber including signals reflected back from the sensor of each object. The OTDR system is of a well known type so that no detailed explanation is required here.

The sensor 11 of each object is connected to the fiber 13 by a respective tap coupler 15 which extracts a part only of the transmitted optical signal on the fiber 13 for transmission to the sensor 11 while a further part of the optical signal continues on the fiber. Thus it will be noted that the fiber portion 13A connects to the tap coupler 15A which taps off a portion of the signal on a drop 16A leaving a larger portion of the signal to continue along the portion 13B of the fiber 13 to the remaining objects to be monitored.

The sensor 11 of each object 12 is thus arranged to receive a part only of the transmitted optical signal and to reflect back at least a part of the transmitted optical signal. The reflection or return back of the signal supplied to the sensor 11 on the fiber drop 16A from the tap coupler 15 is caused by a coupler 17 which has its outputs 17A and 17B connected to a loop 18 of fiber so that the fiber 18 simply returns the signal to the coupler 17 to be introduced back into the fiber 13 by the tap coupler 15.

The OTDR processor is, as conventional, arranged to generate an output 14A to a display 14B which indicates and identifies receipt of a reflected signal received from the sensor of each object.

The movable member of the sensor each object is arranged to change a level of reflectance of the sensor so as to change a proportion of the optical signal which is reflected back.

Thus on the display at 14C it will be noted that the signal displayed includes for each sensor a respective trace. When all of the objects are in the first condition 1, all of the sensors reflect back a high return signal which provides a high trace on the display. In the event that the object moves to the second condition, the reflectance of the sensor is changed, typically to a much lower level so that the trace collapses to a low level or even a zero level so that this is immediately and directly visible as shown. That is the output 14A of the OTDR processor 14 is arranged to indicate the change in the level of reflectance of the sensor of the objects in a way that is immediately apparent to an observer or to an output sensor so that an alarm can be emitted by the observer or automatically by the output sensor as required.

The arrangement herein is typically used for a series of objects and their associated sensors but can in some cases be used for monitoring a single object, using the same high and low reflectance levels from the sensor of the object.

Thus each object 10 is movable between first and second conditions as shown at 10A and 10B and so that the movable member 12 of the respective sensor is arranged to change a level of reflectance of the respective sensor. This acts so as to change a proportion of the optical signal which is reflected back or returned from a high reflectance at the first condition to a low reflectance at the second condition.

In the embodiments of FIG. 1 to 5, this change in the reflectance is obtained by looping back to the fiber through the coupler 17 the part of the received thereby. In these cases, the level of reflectance is changed by attenuating an amount of the signal which is looped back. In this way the whole signal is looped back in the first condition and the movable member is arranged to introduce an attenuation in the signal as it is being looped back so as to lower the level of the signal and thus lower the reflectance level.

In the embodiments of FIGS. 1 to 4, the movable member is arranged to change a level of reflectance of the sensor by passing the optical signal through the loop 18 of fiber and attenuating the signal by bending the loop of fiber. It is well known that a macrobend in the fiber will cause the signal transmitted therethrough to be attenuated by an amount generally proportional to the amount of bending so that the movable member is arranged to provide a bending action sufficient to transition between high and low levels of reflectance which are readily visible on the display 14B.

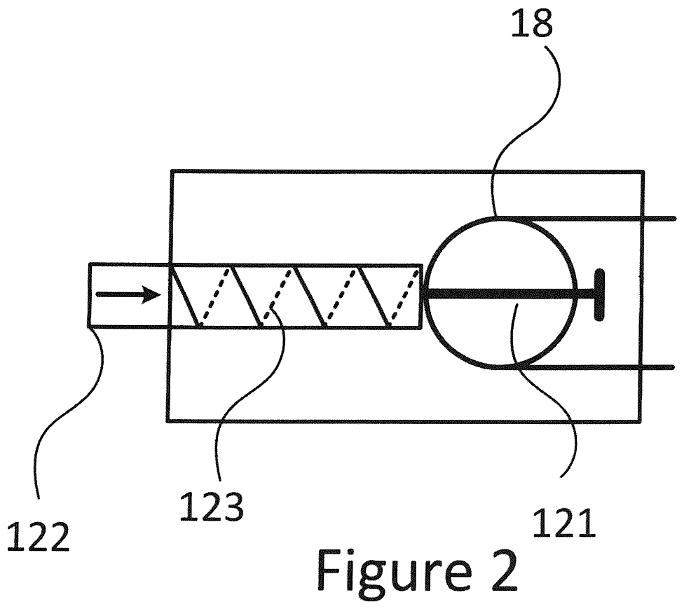

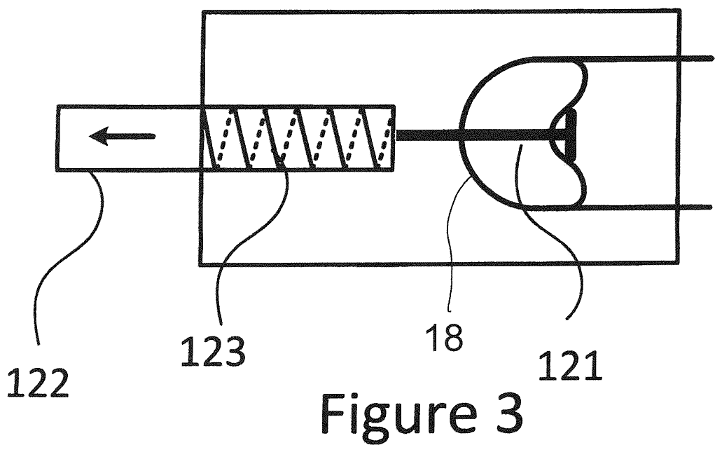

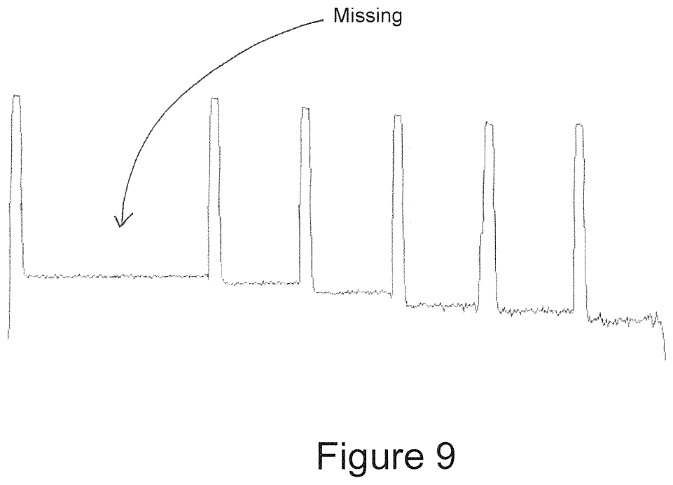

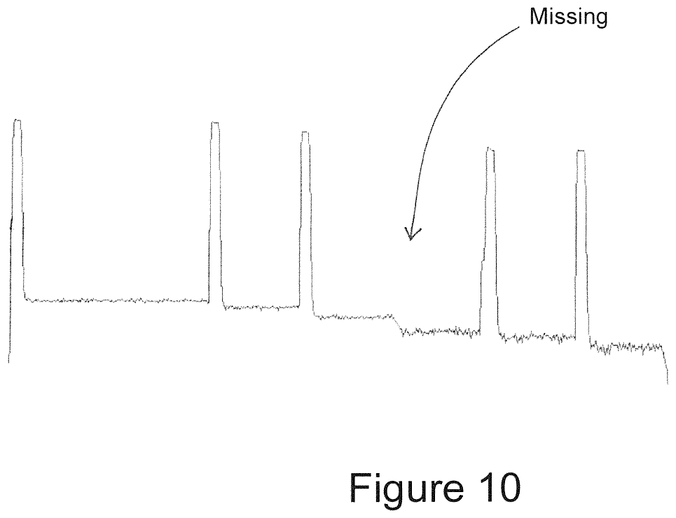

In the arrangement shown in FIG. 1, the movable member 12 operates simply on the loop at one tangent to the loop to press radially inwardly to provide the macro-bending action. This simple arrangement cannot provide the two discrete conditions of open and closed since the opening movements gradually bends the loop rather than provide two discrete positions. A more practical arrangement is shown in FIGS. 2 and 3 where an actuator 121 operates on the loop 18 but has two discrete position provided by a connection of the actuator 121 to a movable member 122 the movement of which is controlled by a spring 123. Shown in FIG. 2 is the sensor system in a state of engaged, such as the door being closed and the plunger 122 displacing the actuator 121 such that the fiber loop 18 is in a state of not distorted or macrobent. This condition will report to the OTDR 14B a non-attenuated reflection as in FIG. 9. Opening the monitored door presents the condition of FIG. 3 wherein spring 123 forces plunger 122 forward, causing macrobend or compression on fiber loop 18. This macrobending will cause attenuation of the reflected signal, as displayed in FIG. 10 as a missing pulse.

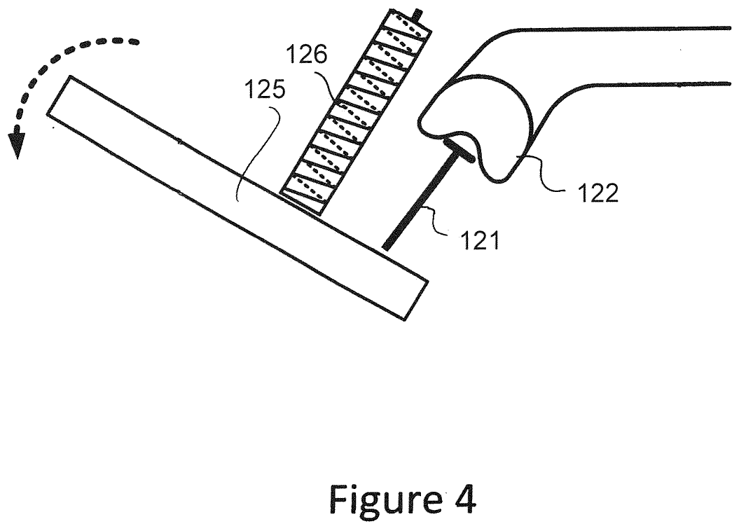

Continuing to FIG. 4, the actuator as described above is engaged by a lever arm 125 extending from the enclosure controlled by a spring 126. Functioning similarly to FIGS. 2 and 3 above, closing the monitored door relaxes the fiber loop 18, and causes an unattenuated reflection to be reported to OTDR 14B. Opening the monitored door causes the monitoring loop 18 to be compressed by the pin 121, causing the reflection to be attenuated.

It will be appreciated that many other mechanical connections can be provided which connect movement of an object to compression of the loop 18 with either two distinct conditions as required in this embodiment or in a gradated movement if required for gradated monitoring.

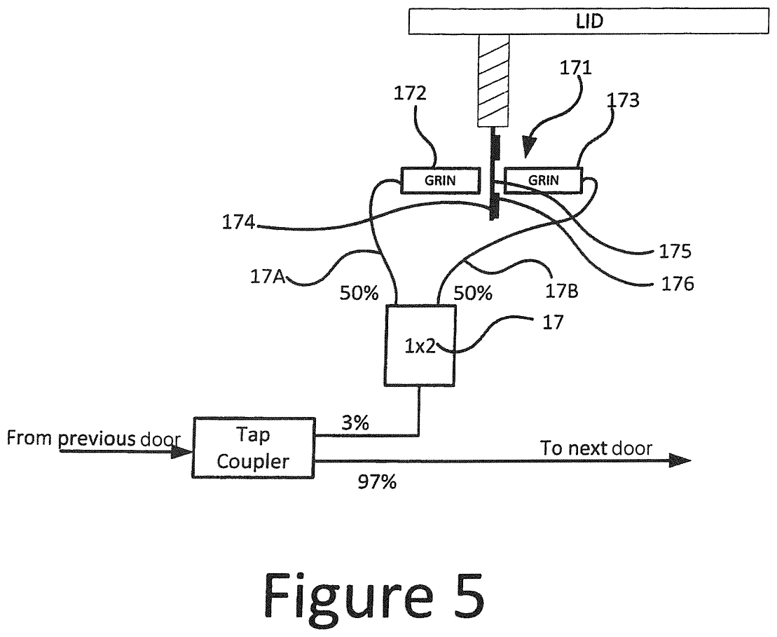

In another alternative embodiment shown in FIG. 5 the movable member is arranged to reflect back or loop back the optical signal by transmitting the optical signal across a space 171 between collimating lens arrangements 172 and 173 and to change a level of reflectance of the sensor by attenuating the optical signals in the space 171 using an obstacle 174 having an opening 175 and a blocking portion 176. With monitored door in the closed position, obstacle 174 is aligned such that light emanating from lens 173 is collected by lens 172 and injected into coupler 17. Concurrently, light from lens 172 is collected by lens 173 and injected into coupler 17. This condition will report to the OTDR 14B a non-attenuated reflection as in FIG. 9. With the monitored door in the open position, the light exiting each lens is blocked from entering the opposite lens, causing attenuation of the reflected signal being reported to OTDR 14B, as displayed in FIG. 10.

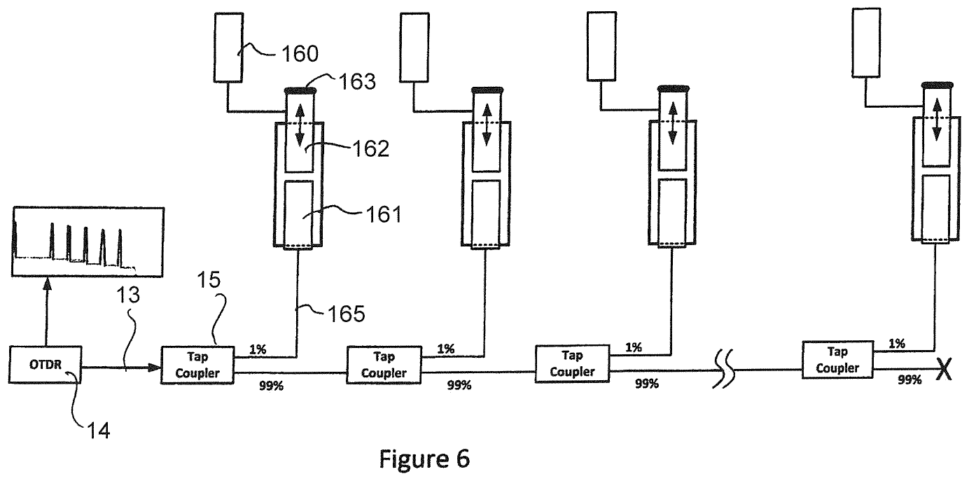

In another alternative embodiment shown in FIGS. 6, 7 and 8, the movable member 160 is arranged to change a level of reflectance of the optical signal by the sensor by providing a termination 161 at an end of a fiber 165 which provides a first level of reflectance at the termination 161 and by bringing into engagement with the termination 161 a component 162 which allows the optical signal to enter the component from the termination and to have a second level of reflectance which is different from the first level of reflectance. The component 162 comprises a ferrule with an end 163 of the ferrule which provides the second level of reflectance.

In FIG. 6, the fiber is terminated by a perpendicular face of a stationary ferrule 161 which provides a Physical contacting back reflection and the movable ferrule 162 provides a connection to the perpendicular face which allows the signal to enter the ferrule 162 which has a non-reflecting end 163 provided by a non-reflecting coating such as an index matching gel.

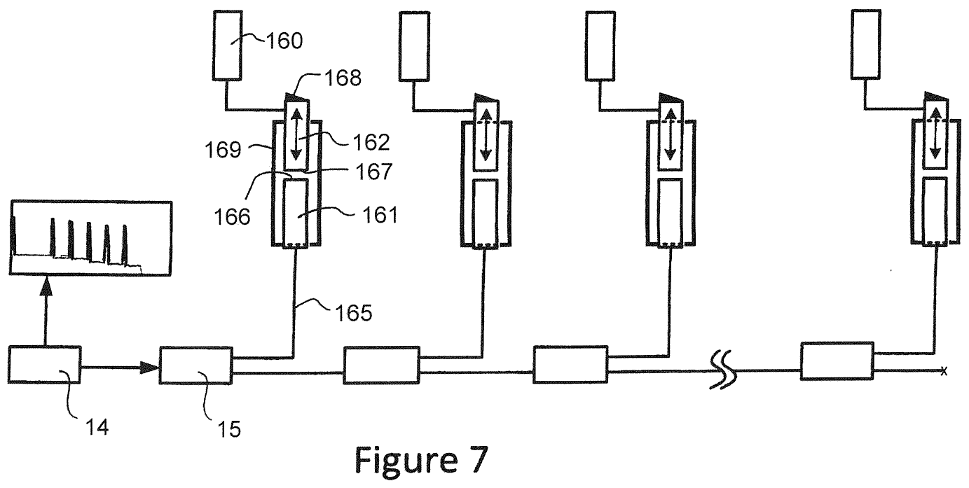

Thus for example in FIG. 7, the fiber is terminated by a perpendicular face 166 of a stationary ferrule 161 which provides a Physical contacting back reflection and wherein the movable ferrule 162 provides a connection 167 to the perpendicular face 166 which allows the signal to enter the ferrule 162 which has a non-reflecting end 168.

With monitored door in the closed position, the movable ferrule 162 within a guiding sleeve 169 makes contact with the stationary ferrule 161. The light injected into the stationary ferrule 161 from the fiber 165 is coupled into the movable ferrule 162. In this way the non-reflection caused by the angled face 168 of the movable ferrule 162 becomes the dominant function and injects a non-reflection back into the fiber 165. This condition will report to the OTDR 14 an attenuated reflection as in FIG. 10. With monitored door in the open position, the movable ferrule 162 within the guiding sleeve 169 does not makes contact with the stationary ferrule 161. The light injected into the stationary ferrule 161 is not coupled into the movable ferrule 162 In this way the reflection caused by the non-angled face 166 of the stationary ferrule 161 becomes the dominant function and injects a reflection into the fiber 165. This condition will report to the OTDR 14 a non-attenuated reflection as in FIG. 9.

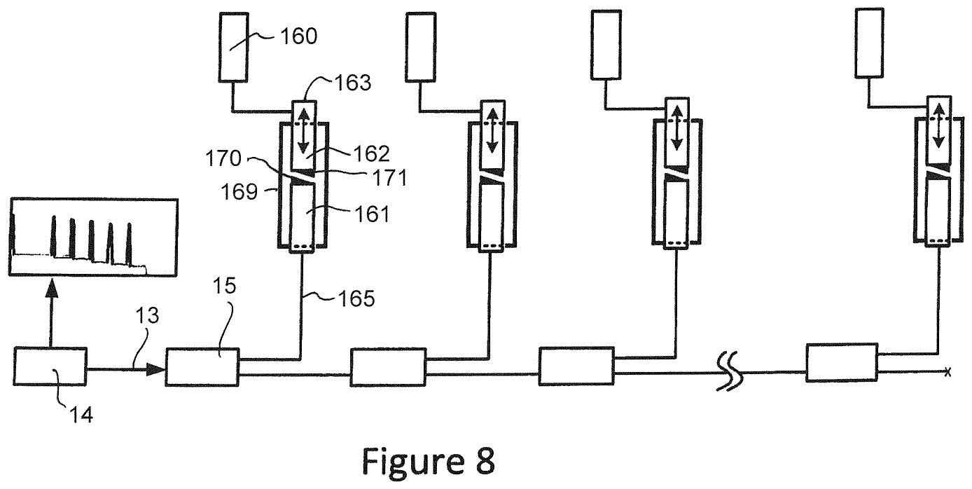

Further for example in FIG. 8, the fiber 165 is terminated by an angled, non-reflective face 170 of a stationary ferrule 161 which provides a non-reflection to the fiber 165 and wherein the movable ferrule 162 provides a connection 171 to the angled face 170 which allows the signal to enter the movable ferrule 162 which has a reflecting end 163.

With monitored door in the closed position, movable ferrule 162 within the guiding sleeve 169 makes contact with the stationary ferrule 161. The light injected into the stationary ferrule 161 is coupled into the movable ferrule 162 and in this way the reflection caused by the reflective face 163 of the movable ferrule 162 becomes the dominant function and injects a reflected signal into the fiber 165. This condition will report to the OTDR 14B a reflection as in FIG. 9. With monitored door in the open position, movable ferrule 162 within the guiding sleeve 169 does not make contact with the stationary ferrule 161. The light injected into the stationary ferrule 161 is not coupled into the movable ferrule and in this way the attenuation caused by the angled face 170 of the stationary ferrule 161 becomes the dominant function and injects no reflection into the fiber. This condition will report to the OTDR 14B a non-reflection as in FIG. 10.

1. A method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
placing the sensors of said at least one object in contact with said optical sensor fiber;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensor of said at least one object;
wherein the sensor of said at least one object is connected to the optical sensor fiber by a respective tap coupler which extracts a part only of the transmitted optical signal for transmission to the sensor while a further part of the optical signal continues on the optical sensor fiber;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensor of said at least one object.

2. The method according to claim 1 for monitoring a plurality of objects for changes in condition of each of the objects comprising:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein each sensor is connected to the optical sensor fiber by a respective one of a plurality of tap couplers each of which extracts a part only of the transmitted optical signal for transmission to the sensor while a further part of the optical signal continues on the optical sensor fiber to others of the sensors;
wherein the movable member of each respective sensor is arranged to change a level of reflectance of the respective sensor so as to change a proportion of the optical signal which is reflected back;
and wherein the output of the OTDR processor is arranged to indicate the change in the level of reflectance of each of the sensors.

3. The method according to claim 1 wherein said at least one object is movable between first and second conditions and wherein the movable member of the respective sensor is arranged to change a level of reflectance of the respective sensor so as to change a proportion of the optical signal which is reflected back from a high reflectance at the first condition to a low reflectance at the second condition.

4. The method according to claim 3 wherein the first and second conditions relate to specific first and second positions of the object to be monitored.

5. The method according to claim 1 wherein the sensor of said at least one object is arranged to receive at least part of the transmitted optical signal and to reflect back at least a part of the transmitted optical signal received thereby by looping back to the optical sensor fiber said at least part of the received thereby and wherein the level of reflectance is changed by attenuating an amount of the signal which is looped back.

6. The method according to claim 5 wherein the signal is looped back by a coupler.

7. The method according to claim 1 wherein each of the objects is movable between first and second conditions and wherein the movable member of each respective sensor is arranged to change a level of reflectance of the respective sensor so as to change a proportion of the optical signal which is reflected back from a high reflectance at the first condition to a low reflectance at the second condition and wherein the output indicates and identifies that all of the sensors are in the first condition by receipt from each of the sensors of a high reflected signal at the high reflectance and indicates and identifies which of the sensors are in the second condition by receipt from each of the sensors of a low reflected signal at the low reflectance such that the output visually shows which of the sensors are in the second condition.

8. The method according to claim 1 wherein the movable member is arranged to change a level of reflectance of the sensor by passing the optical signal through a loop of fiber and attenuating the signal by bending the loop of fiber.

9. The method according to claim 1 wherein the movable member is arranged to reflect back the optical signal by transmitting the optical signal across a space between collimating lens arrangements and to change a level of reflectance of the sensor by attenuating the optical signals in the space.

10. The method according to claim 1 wherein the movable member is arranged to change a level of reflectance of the optical signal by the sensor by providing a termination at an end of a fiber which termination provides a first level of reflectance at the termination and by bringing into engagement with the termination a component which allows the optical signal to enter the component from the termination and to have a second level of reflectance which is different from the first level of reflectance.

11. The method according to claim 10 wherein the component comprises a ferrule with an end of the ferrule which provides the second level of reflectance.

12. The method according to claim 10 wherein the fiber is terminated by a perpendicular face which provides a Physical contacting back reflection and wherein the ferrule provides a connection to the perpendicular face which allows the signal to enter the ferrule which has a non-reflecting end.

13. The method according to claim 10 wherein the fiber is terminated by an angled face which provides an Angled Physical contacting back reflection which prevents the signal from being returned in the fiber and wherein the ferrule provides a connection to the angled face which allows the signal to enter the ferrule which has a reflecting end.

14. The method according to claim 1 wherein the changes in condition of the objects move through a series of different conditions and wherein the level of reflectance is graduated through different values depending on said conditions.

15. A method for monitoring a plurality of objects for changes in condition of each of the objects comprising:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein the movable member of each respective sensor is arranged to change a level of reflectance of the respective sensor so as to change a proportion of the optical signal which is reflected back;
wherein each of the objects is movable between first and second conditions;
wherein the movable member of each respective sensor is arranged to change a level of reflectance of the respective sensor so as to change a proportion of the optical signal which is reflected from a high reflectance at the first condition to a low reflectance at the second condition;
and wherein the output indicates and identifies that all of the sensors are in the first condition by receipt from each of the sensors of a high reflected signal at the high reflectance and indicates and identifies which of the of sensors are in the second condition by receipt from each of the sensors of a low reflected signal at the low reflectance such that the output visually shows which of the sensors are in the second condition.

16. A method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensors of said at least one object;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensors of said at least one object;
wherein the sensors of said at least one object is arranged to receive at least part of the transmitted optical signal and to reflect back at least a part of the transmitted optical signal received thereby by looping back to the optical sensor fiber said at least part of the signal received thereby;
and wherein the signal reflected back from each of the sensor of said at least one object is changed by attenuating an amount of the signal which is looped back.

17. The method according to claim 16 for monitoring a plurality of objects for changes in condition of each of the objects comprising:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein each sensor is connected to the optical sensor fiber by a respective one of a plurality of tap couplers each of which extracts a part only of the transmitted optical signal for transmission to the sensor while a further part of the optical signal continues on the optical sensor fiber to others of the sensors;
wherein the movable member of each respective sensor is arranged to change a level of reflectance of the respective sensor so as to change a proportion of the optical signal which is reflected back;
and wherein the output of the OTDR processor is arranged to indicate the change in the level of reflectance of each of the sensors.

18. A method for monitoring at least one object for changes in condition of said at least one object comprising:
providing a sensor for said at least one object, the sensor including a movable member responsive to a change in condition of said at least one object to be monitored;
providing an optical sensor fiber extending to said at least one object to be monitored;
using an OTDR processor in communication with said optical sensor fiber for transmitting an optical signal along said optical sensor fiber and for receiving therefrom signals reflected back on said optical sensor fiber including signals reflected back from the sensor of said at least one object;
the sensor of said at least one object being arranged to receive at least part of the transmitted optical signal and to reflect back at least a part of the transmitted optical signal;
the OTDR processor being arranged to generate an output which indicates and identifies receipt of a reflected signal received from the sensors of said at least one object;
wherein the movable member of the sensor of said at least one object is arranged to change a level of reflectance of the sensor so as to change a proportion of the optical signal which is reflected back;
and wherein the output of the OTDR processor is arranged to indicate the change in the level of reflectance of the sensors of said at least one object;
wherein the sensors of said at least one object is arranged to receive at least part of the transmitted optical signal and to reflect back at least a part of the transmitted optical signal received thereby by transmitting the optical signal across a space between collimating lens arrangements and to change a level of reflectance of the sensor by attenuating the optical signals in the space.

19. The method according to claim 18 for monitoring a plurality of objects for changes in condition of each of the objects comprising:
providing a plurality of sensors at spaced locations, each having a movable member responsive to a change in condition of a respective one of the objects to be monitored;
providing an optical sensor fiber extending to each of the objects to be monitored;
placing the plurality of sensors at said spaced locations in contact with said optical sensor fiber;
using an OTDR processor in communication with said optical sensor fiber for transmitting an optical signal along said optical sensor fiber and for receiving therefrom signals reflected back on said optical sensor fiber including signals reflected back from each of said sensors;
each of the sensors being arranged to receive at least part of the transmitted optical signal and to reflect back at least a part of the transmitted optical signal;
the OTDR processor being arranged to generate an output which indicates and identifies receipt of a signal reflected back from each of the sensors;
wherein each sensor is connected to the optical sensor fiber by a respective one of a plurality of tap couplers each of which extracts a part only of the transmitted optical signal for transmission to the sensor while a further part of the optical signal continues on the optical sensor fiber to others of the sensors;
wherein the movable member of each respective sensor is arranged to change a level of reflectance of the respective sensor so as to change a proportion of the optical signal which is reflected back;
and wherein the output of the OTDR processor is arranged to indicate the change in the level of reflectance of each of the sensors.
